(19) United States
(12) Patent Application Publication
(10) Pub. No.: US 2008/0308492 A1
(43) Pub. Date: Dec. 18, 2008

(54) Filter Medium for Technical Applications, and Method for the Production Thereof

(76) Inventor: Sven Siegle, Winnenden (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/995,507

(22) PCT Filed: Jul. 12, 2006
(86) PCT No.: PCT/DE06/01208

§ 371 Date: Jul. 16, 2008

(30) Foreign Application Priority Data
Jul. 12, 2005 (DE) 10 2005 032 395.2

(51) Int. Cl. B01D 39/16; C08F 2/46

(52) U.S. Cl. 210/508; 427/487

(57) ABSTRACT

The invention relates to a method for producing a filter medium for technical applications. According to said method, a bellows made of a filter paper is impregnated with a resin, and the resin-impregnated bellows is then radiation-cured. The invention also relates to a filter medium for technical applications, which is provided with a radiation-cured resin layer.

The present invention relates to a filter medium for technical applications, in particular for the automotive industry and as industrial filters as well as a method for manufacturing same.

Filter media for automotive and industrial filters are generally special and finished filter papers based on cellulose. They are used for filtering air, fuel and oils and must meet very high demands regarding the bursting strength and tensile strength with a long service life and in some cases high temperature stresses in an aggressive environment.

Of course the starting material, the filter paper must itself be characterized by the maximum possible bursting strength and tensile strength, which can be achieved only with long chain lengths, a strong interaction of fiber molecules with one another and optimal curing of the resin. The bursting strength of the filter paper should amount to at least 0.1 N/mm².

Fundamental findings regarding the dependence of the strength properties of cellulose on the degree of polymerization can be traced back to Staudinger (H. Staudinger, F. Reinecke “Macromolecular Compounds—Characterization of Celluloses by Determination of Viscosity” in Der Papierfabrikant volume 36, page 489 (1938)). These investigations showed that with a reduction in the degree of polymerization of cellulose to a value of approximately 1,000, no significant decline in strength properties of the paper can be observed but fibers below a degree of polymerization of cellulose of approximately 900 lose a great deal of strength, which is documented by a definite reduction in the bursting pressure, the tear propagation resistance and the number of folds of the cellulose.

The degree of polymerization of filter paper, which is usually used to produce the present technical filter media, is generally between 1,000 and 2,000.

Technical filter papers are generally made of short-fiber cellulose and long fiber cellulose from southern long fibers in a high degree of purity with a high alpha-cellulose content and a low lignin content and polyose content. These technical filters are also highly porous—also referred to as dissolving pulp—and generally contain a certain amount of mercerized cellulose.

According to H. Staudinger and F. Reinecke “Macromolecular Compounds—The Degree of Polymerization of Various Celluloses” in Holz als Roh-und Werkstoff [Wood as a Raw Material and Working Material], volume 2, page 321 (1939), a degree of polymerization of 1,000 is a critical limit.

The dependence of the degree of polymerization, which is essential for the strength of paper, was investigated by K. Fischer, I. Schmidt and S. Fischer as a function of the radiation dose (“Radiochemical Changes in Cellulose and the Effects on Derivatization” in Das Papier, volume 51, pages 629-636 (1997)), in which these investigations proved an exponential reduction in the degree of polymerization of cellulose depending on the radiation dose and an increase in reactivity of cellulose. With radiation of 5 kGy, for example, the degree of polymerization of cellulose drops from 900 to approximately 600 and with radiation of 10 kGy it drops to approximately 500.

Other follow-up reactions of the cellulose radicals formed by electron bombardment include in addition to chain degradation also elimination reactions as well as the formation of carbonyl groups and carboxyl groups.

Industrial filter papers are also characterized in particular by the resinification system, which is not present in household filters or other papers. The water absorbency is therefore greatly restricted with these types of paper (in the cured state), so the equilibrium moisture content is very low, amounting to approximately 3 to 5 wt %. The swelling power of industrial filter papers is also greatly hindered. Thus, a very high dimensional stability is also achieved.

In general, typical technical filter papers have a grammage of 100-300 gsm, a thickness between 0.5 and 0.9 mm and a hydrophobicity of 0 in the uncured state without a coating and approximately 7 in the fully cured state.

The thermal stress on an oil filter amounts to approximately 150° C. while that on a fuel filter amounts to approximately 70° C. to 80° C. Air filters must also have the required stability with great temperature fluctuations.

In the case of oil filters, the air permeability generally amounts to between 200 and 800 L/m²·s, in particular approximately 500 L/m²·s; MFP: 20-30 micrometers and the filter unit 10 to 20 micrometers and especially approximately 14 micrometers. With typical fuel filters, the air permeability amounts to in general approximately 5 to 20 L/m²·s, MFP 5-8 micrometers and the filter fineness approximately 1-10 micrometers. Typical air filters are characterized by an air permeability of approximately 250-700 L/m²·s, MFP 20-30 micrometers and a filter fineness of 10-20 micrometers.

At low temperatures, there may also be a considerable increase in viscosity up to jellifying of the fluids to be filtered, such as diesel or oils. The filter materials must also withstand these high pressures and the additional mechanical stress.

In the case of oil filters, the acidic conditions, which can result in degradation of cellulose fibers, can be mentioned as additional stresses to which the filter material is subjected.

Since the intervals until replacement of a filter have also become longer and longer, the required strength properties and other mechanical properties of the filter materials must also be retained for a longer period of time, even under a high temperature burden and in an aggressive chemical environment.

Within the scope of the process of manufacturing the finished filter medium, the filter paper is folded, in particular to form expansion bellows, and embossed. In order for this mechanical shaping of the filter paper to withstand the subsequent application, to achieve a certain hydrophobicity of the paper and to increase the strength, in particular the bursting strength and tensile strength and resistance of the paper, the filter paper impregnated with the resin system is then cured in an oven. In doing so, the paper, having been embossed with nubs and folded to form expansion bellows, is conveyed on a conveyor belt through the oven at a temperature between 160° C. and 200° C. to induce thermal crosslinking of the resin.

It is known that filter paper can be impregnated with novolaks in resin form, the novolaks then being heat cured by means of hexamethylenetetramine because novolaks as such do not undergo further crosslinking under the influence of heat.

If novolaks cured with hexamethylenetetramine are used as the resins, then in heating in an oven, volatile compounds such as formaldehyde or ammonia are released. In thermal curing of other resins, emissions of solvents or resin components are also released. These and other compounds released from the resin during heating must be removed with suction in a complex procedure and the exhaust gases must then be filtered and/or purified.

At the temperatures up to 200° C. prevailing in the oven, the vapor pressure of the resin or individual components in the resin is also so high that the resin or individual components of the resin evaporate and can then be deposited on cooler surfaces such as the conveyor belts, oven walls or rails. These condensed resins or resin constituents lead to considerable problems in the production of filter inserts, in particular when paper surfaces or coatings finished with these resin components are abraded.

Condensation of the resins or resin components in the oven results in the entire oven having to be cleaned thoroughly to remove the resin condensates every two weeks to maintain a uniform quality of the filter inserts.

Since the desired further processing of the resins takes place in the resin-impregnated expansion bellows, the entire resin impregnated filter paper must be exposed to the required reaction temperature in the oven for a sufficient period of time, in general approximately one to three minutes. The rate of conveyance of the belt is approximately 4.5 m/min. Since the reaction takes place on expansion bellows, which are placed like a harmonica on the conveyor belt, the exchange of heat and air is different at different locations and on the two sides of the expansion bellows, which results in a local difference in the intensity of crosslinking of the resin in/on the expansion bellows. A high degree of crosslinking is observed in particular on the fold edges of the bellows facing outward without touching the conveyor belt, but a lower degree of crosslinking and therefore also a lower degree of hydrophobicity are achieved in the areas such as the inside surfaces of the acute angles of the expansion bellows, where heat exchange is hindered.

The difference in heat penetration in particular due to the geometric conditions of the expansion bellows results in varying degrees of crosslinking of the resin along the expansion bellows and therefore also variations in the mechanical strength and hydrophobicity of the filter paper. Bursting or tearing of the filter material may occur precisely due to the less strongly crosslinked and less hydrophobicized area of the filter paper bellows.

Due to the required heating of the resin-impregnated paper, throughput in the oven is limited and heat losses are enormous. Furthermore the oven, which is already approximately seven meters long and is usually set up in the production hall, must also be cooled.

The object of the present invention is thus to provide filter media for technical applications with a more uniform curing and thus strength and hydrophobicity and to provide an inexpensive and environmentally friendly method for manufacturing the filter media.

This object is achieved through the features of claim 1.

It has amazingly been discovered that curing a resin on filter paper can be achieved by radiation curing and the cellulose will have the high strength and load-bearing capacity required for technical applications despite the shortening of the chain length, which is known to occur with radiation in the state of the art and is associated with a definite decline in mechanical stability.

It is assumed that this unexpected result is to be attributed to the fact that a significant portion of the high-energy radiation is absorbed by the resin, so the resin acts as a filter for the high-energy radiation which would damage the fibers so the desired crosslinking of the resin is achieved and damage to the fibers is largely prevented.

Since the radiation absorption does not depend on the geometry and folds of the bellows, a far more uniform crosslinking of the resin over the bellows can be achieved by radiochemical and photochemical reactions which are independent of heat transport and convection processes, i.e., the filter material has a more constant strength and hydrophobicity.

The term “radiation curing” within the scope of the present invention is understood to refer to curing by electron beams, X-rays, gamma rays and UV radiation.

However, radiation curing of a resin can also accelerate and simplify the entire manufacturing process while lowering production costs. Since time-intensive heating of the filter material with the resin is no longer necessary and the free radicals generated by absorbing radiation react immediately, the belts that convey the filter bellows may be operated at a 50-fold to 100-fold speed. The resin-impregnated filter bellows are guided on the conveyor belt to at least one radiation source, where they are optionally irradiated on both sides and the resin is crosslinked more or less instantaneously.

Another important advantage of radiation curing is that no volatile compounds are released from the resin, so that traditional suction venting of emissions originating from the resin and the subsequent treatment and filtering of the exhaust air may be omitted.

Condensation of volatile constituents of the resin on cold parts of the oven and the resulting damage to the filter paper as well as the required cleaning are also avoided.

Another important advantage of radiation curing is the enormous savings in terms of energy, cold water, exhaust air filters and space, because no space-intensive oven which must be heated to 180° C. to 200° C. and must be cooled from the outside at the same time is necessary, suction venting of the products formed by thermal crosslinking such as ammonia or formaldehyde may be omitted and the oven is no longer soiled by condensed resins. The energy consumption for polymerization of the resin may be lowered by more than 90% to 1/50th to 1/100th of the energy required in the past by using the radiation-curable resin.

A number of monomers, oligomers, prepolymers and polymers may be used as the radiation-curable resins, e.g., saturated or unsaturated resins based on phenol or based on polyesters, polyester acrylates, epoxy resins, epoxy acrylates, urethanes and urethaneacrylates, polyether acrylates, olefinic resins or silicone acrylates.

In as much as the respective resin or individual resin components react due to the radiation itself to form free radicals by means of which additional monomers, oligomers or (pre)polymers in the resin may be attacked, addition of free-radical-forming agents, free-radical reactants or spacers is not necessary.

Preferably at least individual resin components have unsaturated molecular groups for this purpose such as acryl, methacryl, vinyl or allyl groups, for example. Molecular groups comprising several and/or conjugated unsaturated compounds, whether they are unsaturated C—C bonds, unsaturated bonds between carbon and a heteroatom or strictly heteroatomic unsaturated compounds may also be used as the molecular groups that form free radicals.

Free radical formation may in principle also take place on saturated radicals, in particular those having heteroatoms.

Insertion of such groups which form free radicals on irradiation may be accomplished in the case of phenolic resins, e.g., by substitution reactions, by functional or free-radical-forming groups, e.g., C═C groups or functional groups which comprise the spacers listed below.

Inasmuch as the resins or resin components do not form reactive further crosslinking free radicals themselves, it is possible to use radical-forming spacers or radical initiators, e.g., 1,5-hexadien-3-ol, 1,4-pentadien-3-ol, 2-methyl-1,3-butadiene.

The spacers are preferably compounds containing acrylates or carboxylates, urea derivatives, allyl or vinyl groups or siloxane compounds and are preferably selected from the following groups in particular:

1,3-Butanediol diacrylate, 1,4-butanediol diacrylate, 1,6-hexanediol diacrylate, 1,6-hexanediol ethoxylate diacrylate, 1,6-hexanediol propoxylate diacrylate, 5-ethyl-5-(hydroxymethyl)-β,β-dimethyl-1,3-dioxane-2-ethanol diacrylate; bisphenol-A ethoxylate diacrylate, bisphenol-A glycerolate (1-glycerol/phenol) diacrylate, bisphenol-A-propoxylate diacrylate, bisphenol-F ethoxylate (2 EO/phenol) diacrylate;
Di-(ethylene glycol)-diacrylate, ethylene glycol-diacrylate, fluoresceine-0,0′-diacrylate, glycerin-1,3-diglycerolate diacrylate, neopentyl-glycol-diacrylate, neopentyl-glycol-propoxylate (1 PO/OH)-diacrylate, pentaerythritol-diacrylate-monostearate, poly(disperse-red9-p-phenylen diacrylate), poly(ethylene glycol)-diacrylate, poly(propylene glycol)-diacrylate, propylene glycol-glycerolate diacrylate, tetra(ethylene glycol)-diacrylate, tri(propylene glycol)-glycerolate diacrylate, tricyclo[5.2.1.0^{2,6}]decandimethanol diacrylate, trimethylolpropane-benzoate diacrylate, trimethylolpropane-ethoxylate(1 EO/OH)-methyletherdiacrylate;
1,3,5-Triallyl-1,3,5-triazine-2,4,6 (1H, 3H, 5H)-trione, 3-(N,N′,N′-triallyl-hydrazino)-propionic acid, triallyl 1,3,5-benzenetricarboxylate, triallyl borate, triallyl cyanurate, 2,4,6-triallyloxy-1,3,5-triazine, trimethylol-propane ethoxylate triacrylate, glycerol-propoxylate (1 PO/OH) triacrylate, pentaerythritol propoxylate triacrylate, pentaerythritol triacrylate, trimethylol-propane propoxylate triacrylate, trimethylolpropane triacrylate;
Diallyl-2,6-dimethyl-4-(3-phenoxyphenyl)-1,4-dihydro-3,5-pyridinedicarboxylate, diallyl-2,6-dimethyl-4-(4-methyl-phenyl)-1,4-dihydro-3,5-pyridinedicarboxylate, diallyl-4-(2,4-dichlorophenyl)-2,6-di-methyl-1,4-dihydro-3,5-pyridinedicarboxylate, diallyl-4-(2-chlorophenyl)-2,6-dimethyl-1,4-dihydro-3,5-pyridinedicarboxylate; 1,1-Diallyl-1-docosanol, 1,1-diallyl-3-(1-naphthyl)-urea, 1,1-diallyl-3-(2,3-dichlorophenyl)-urea, 1,1-diallyl-3-(2,3-xylyl)-urea, 1,1-diallyl-3-(2,4,5-trichlorophenyl)-urea, 1,1-diallyl-3-(2,4-dichlorophenyl)-urea, 1,1-diallyl-3-(2,4-xylyl)-urea, 1,1-diallyl-3-(2,5-dichlorophenyl)-urea, 1,1-diallyl-3-(2,5-xylyl)-urea, 1,1-diallyl-3-(2,6-dichlorophenyl)-urea, 1,1-diallyl-3-(2,6-diethylphenyl)-urea, 1,1-diallyl-3-(2,6-diisopropylphenyl)-urea, 1,1-diallyl-3-(2,6-xylyl)-urea, 1,1-diallyl-3-(2-ethyl-6-methylphenyl)-urea, 1,1-diallyl-3-(2-ethylphenyl)-urea, 1,1-diallyl-3-(2-methoxy-5-methylphenyl)-urea, 1,1-diallyl-3-(2-methoxyphenyl)-urea, 1,1-diallyl-3-(2-methyl-6-nitrophenyl)-urea, 1,1-diallyl-3-(3,4-dichlorophenyl)-urea, 1,1-diallyl-3-(3,4-xylyl)-urea, 1,1-diallyl-3-(3,5-xylyl)-urea, 1,1-diallyl-3-(3-chlorobenzo(β)thiophene-2-carbonyl)-thiourea;
1,3-Divinyl-5-isobutyl-5-methylhydantoin, 1,4-butadiol divinyl ether, 1,4-cyclohexanedimethanol divinyl ether (preferably as a mixture of isomers), 1,4-divinyl-1,1,2,2,3,3,4,4-octamethyltetrasilane, 1,6-hexanediol divinyl ether, 3,6-divinyl-2-methyltetrahydropyrane, 3,9-divinyl-2,4,8,10-tetraoxaspiro[5.5]undecane, di-(ethylene glycol) divinyl ether, divinylsulfone, divinylsulfoxide, platinum(0) 1,3-divinyl-1,1,3,3-tetramethyldisiloxane (complex solution), poly(dimethylsiloxane-co-diphenyl-siloxane) (divinyl terminated), poly(ethylene glycol)-divinyl ether, tetra(ethylene glycol) divinyl ether, 1,1,3,3-tetramethyl-1,3-divinyldisiloxane, 1,4-pentadien-3-ol, polymer carrier VA-Epoxy®, protoporphyrin IX, protoporphyrin IX disodium salt or protoporphyrin IX zinc (II).

The spacers listed above can be ordered from Sigma-Aldrich Co., for example.

Instead of the above-mentioned spacers, the respective substituted spacers or their homologs may be used, for example.

In particular in the case of the phenolic resins that are not already substituted with radiation-curable groups that form free radicals, crosslinking may be accomplished by using spacers, preferably polyfunctional spacers, especially those from the group of di and triacrylates, in particular the alkanol or alkoxyacrylates. Examples of such spacers include 1,6-hexanediol diacrylate (HDDA), tripropylene glycol diacrylate (TPGDA) or dipropylene glycol diacrylate (DPGDA) as bifunctional spacers, trimethylolpropane triacrylate (TMPTA) as trifunctional spacers and pentaerythritol triacrylate (PETIA), pentaerythritol triacrylate, poly(ethylene glycol) diacrylate, trimethylolpropane propoxylate triacrylate, 1,6-hexanediol diacrylate, tetra(ethylene glycol) diacrylate, 1,6-hexanediol ethoxylate diacrylate, bisphenol-A ethoxylate diacrylate and trimethylolpropane ethoxylate triacrylate.

The different batches and types of spacers may of course also be combined with one another to obtain the desired properties.

Ultimately other systems, preferably at least bifunctional systems which form free radicals when exposed to radiation may be used as the spacers, e.g., molecules of the form B-R-A-R-B, which form free radicals of the type .R-A-R-B when exposed to electron bombardment. These free radicals can react with the novolak to form novolak-R-A-R-B∀; then another attack on a novolak to form novolak-R-A-R-novolak may be performed by splitting off another B.

An example of such spacers that form free radicals include the bisazides N₃—Ar—N₃ that react as follows:

An example of such spacers that form free radicals include the bisazides N₃—Ar—N₃ that react as follows:

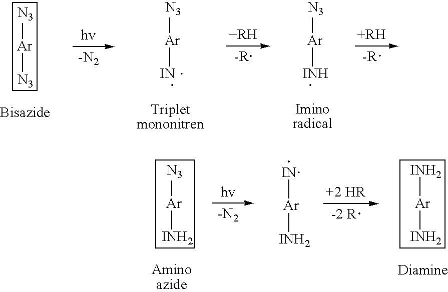

The radical reacts as follows with the novolak to form novolak-R-A-R-B.:

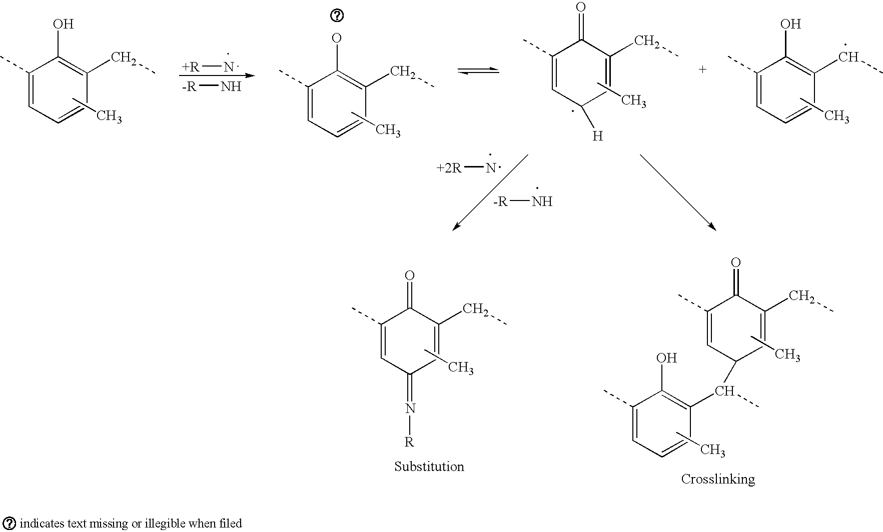

It is also possible in principle to cationically polymerize the resins by radiation. Cationic polymerization can be initiated via suitable salts, e.g., sulfonium-iodonium-diazonium. These salts also react to the electron bombardment and disintegrate, forming acids suitable for cationic polymerization.

Phenolic resins that may be used for radiation curing are obtained by synthesis of phenols with aldehydes. By electrophilic substitution, three hydrogen atoms of the phenol molecule here are replaced by one CH₂—OH group each. By splitting off water, these polyfunctional phenol derivatives condense to form precondensates.

The polycondensation proceeds according to the following reaction:

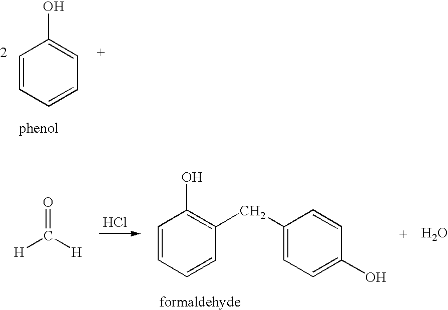

etc.

Depending on the desired result, the precondensates are then mixed with acidic or basic condensation agents.

In an acidic environment, phenol alcohols (methylol) are formed from the precondensate and are then linked together by methylene bridges to form linear chain molecules, so-called novolaks. They are synthesized by using acids (oxalic acid, hydrochloric acid) and excess phenol and still contain structures that are largely free of methylol groups by further acid condensation because of the phenol excess. They are obtained as soluble, fusible, non-self-curing oligomers, which are therefore stable in storage and have molecular weights in the range of approximately 500 to 5,000 g/mol. Their aromatic rings are linked by methylene bridges.

Novolaks have a very high degree of crosslinking and are spontaneously curing.

With basic condensation agents, however, viscous resins with a low molecular weight known as resols are formed.

They are formed from phenols in an excess of formaldehyde and by means of alkaline catalysis (sodium hydroxide solution or calcium hydroxide).

In a basic medium, the phenol is present as a phenolate anion. In a possible resonance form, the negative charge is localized in ortho position where a formaldehyde molecule is added. The proton in this position may be added to the aldehyde oxygen and may migrate to the phenolate oxygen. These phenol alcoholates are formed rapidly. Resol oligomers with molecular weights of 150 to 600 g/mol are formed by slow condensation reactions; they are linked together by methylene bridges and methylene-ether bridges and also contain hydroxymethyl groups. The structure of the resols is influenced not only by the stoichiometric ratio of the educts but also to a significant extent by the temperature, the solvent, the type and concentration of

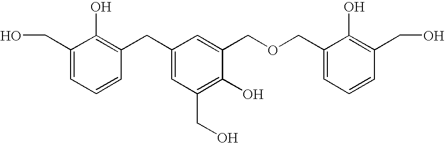

Resols are fusible and soluble in various solvents. They react at room temperature (self-curing phenolic resins) even without other additives, or more rapidly at 100 to 180° C., splitting off water and formaldehyde (polycondensation) and undergoing an increase in molecular size by way of an intermediate stage (resitol) which can still be softened under heat and is still swellable by solvents, leading to the insoluble and infusible end stage (resite). This reaction can be accelerated by adding acid.

If the precondensates are heated at a high pressure, three-dimensional molecular networks are obtained, splitting off more water and formaldehyde molecules.

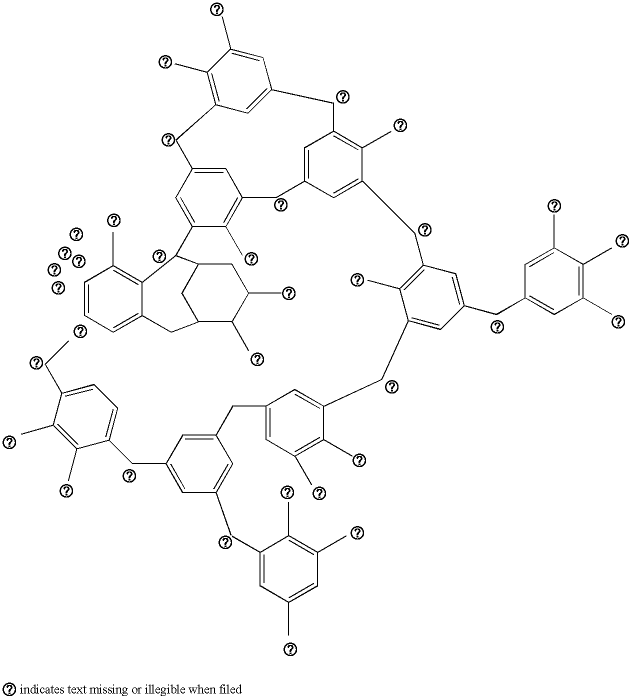

From the field of phenolic resins, the resols and novolaks described above are used today for impregnation. They have the following properties:

Density: 1.3 to 1.45 g/cm³; hard, highly fracture-resistant; color: black/brown/red; never light; turns dark on exposure to light; can be machined only by cutting; burn test: usually flame-resistant; yellowish flame; gives off sparks easily; material cracks and flakes off with a cracking sound and carbonizes; odor of phenol and formaldehyde.

If necessary, a free-radical-forming agent may be added in either stoichiometric or catalytic amount to the resin, the paper in papermaking or subsequently to the resin to be crosslinked.

Depending on the respective radiation-curable resin, it may be advisable to work under a protective gas or at any rate to reduce the oxygen content in the gas mixture surrounding the filter paper to be cured in order to rule out or at least minimize unwanted parallel reactions with oxygen.

Use of protective gas has the additional advantage that it prevents the formation of ozone, which can occur due to irradiation, so that suction removal of ozone may be omitted.

If desired, additional conventional raw materials may also be present in the resin such as polymerizable or polymerization-promoting materials, e.g., binders, reactive diluents (monomers), low-molecular compounds, mono- or polyunsaturated compounds such as acrylate esters and optionally photoinitiators and synergists in the case of UV-curing resins. Likewise, raw materials with other functions such as inhibitors, pigments, dyes, fillers and other additives may also be present in the resin.

For irradiation, in principle high-energy radiation, in particular electron radiation and UV radiation may be used. X-rays or gamma rays, e.g., Co-60 radiation would also be possible in principle. However, according to investigations conducted with regard to irradiation of foods, to avoid the development of radioactivity artificially in any case even at a very high radiation dose, only X-rays of less than 5 MeV and electron rays of less than 10 MeV should be used.

An especially great uniformity of effect is achieved here by using electron bombardment, which presumably originates from the production of secondary electrons and secondary ionization and energization deep in the resin-cured expansion bellows.

The acceleration voltage for electron beam installations depends on the desired depth of penetration and is preferably approximately 90 to 200 kV. The energy dose of the filter paper to be irradiated in the case of electron bombardment is between 10 and 150 kGy, preferably between 50 and 100 kGy.

In UV irradiation systems, the usable wavelength range is between 240 and 400 nm, i.e., between approximately 3 and 6 eV.

In addition to filter paper on a pure cellulose basis, resin-impregnated filter materials with a synthetic fiber content, e.g., with up to 20 or 50 wt % polyester fibers or even pure synthetic fiber filter materials are also radiation curable. The inventive radiation curing of the resins may be used with success especially with filter papers which cannot withstand much thermal stress due to a special coating material or sensitive components. For special areas of application in which no great stress on the filter materials is required, filter materials may be produced by radiation curing of resins on filter papers to which no resin coating can be applied or at least no industrially producible resin coating has been applied.

Radiation-cured melt-blown papers in which thermal curing of the resins is difficult or impossible because of the softening of the polymer coating which occurs at the curing temperature can be radiation crosslinked.

Radiation curing of resin-impregnated papers is also possible in the case of nano-coated papers. According to another preferred embodiment, the free-radical-forming agents or reactants that form free radicals are already incorporated in to the paper in the required amount during papermaking if the respective resin does not already form free radicals that can crosslink with other resin constituents itself by irradiation.

The present invention will be described in greater detail below on the basis of exemplary embodiments.

### I. Proof of Curing

Curing of the resins can be determined by extraction with acetone (DIN EN ISO 6427) and by determining the hydrophobicity. The curing reaction can also be tracked optically in a bathochromic shift in the absorption band, in particular with the novolaks used here by a yellow coloration that occurs with curing.

### a) Determination of Hydrophobicity

The hydrophobicity is determined using a water-ethanol mixture. One drop of test liquid to be tested is applied from a dropper bottle to the paper to be tested. After one minute, the paper is observed to ascertain whether the test liquid remains standing on the paper as a droplet without penetrating. The greater the hydrophobicity of the paper, the higher the number of the corresponding test liquid.

The individual test liquids are listed below:

| | Ethanol | Water |
|---|---|---|
| Number | wt % | wt % |
| 0 | 0 | 100 |
| 1 | 0.9 | 99.1 |
| 2 | 1.6 | 98.4 |
| 3 | 2.6 | 97.4 |
| 4 | 4.5 | 95.5 |
| 5 | 7.5 | 92.5 |
| 6 | 13.0 | 87.0 |
| 7 | 22.0 | 78.0 |
| 8 | 36.0 | 64.0 |
| 9 | 60 | 40 |
| 10 | 0 | 100 |

It has been found in practice that the above classification of the individual test liquids allows a very precise definition of hydrophobicity. Although solution number 5, for example, remains as a droplet on the paper not only after one minute, but even after fifteen minutes, solution number 6 penetrates within a few seconds.

II. Investigating the Radiation Curing of Novolaks with Different Spacers

Various substances were investigated with respect to their suitability as spacers.

Within the scope of these investigations, first a cellulose pad separated with novolak was impregnated with the spacer and then cured by using electron beams (a).

In addition, a conventional novolak paper which is usually used for heat curing and is impregnated with novolak and hexamethylenetetramine is impregnated with the spacer and then radiation cured (b).

Experiments a) and b) were conducted in parallel to rule out the possibility of influences due to the hexamethylenetetramine present in the commercially acquired novolak paper.

### a) Cellulose Pads

For impregnation, cellulose pads were cut out of samples from the Rayonier Company (type Ultranier J Bat, thickness: 1.225 mm, 920 gsm, dry weight: 92.4%) and mixed with novolak in a glass beaker. The novolak used was from the company Bakelite (type PF 656812, C/B 2067287101, item number 3313699140) and was ordered directly from Bakelite via Gessner.

To promote the impregnation, ultrasound was used for approximately 45 minutes. Drying was performed for 24 hours at room temperature under an exhaust hood.

To determine the increase in hydrophobicity, the hydrophobicity of the novolak-impregnated cellulose was determined as described previously, with a hydrophobicity of 0 being determined for the cellulose impregnated only with novolak.

Then the respective spacer to be investigated was applied by drops to the novolak-impregnated cellulose pad and cured with electron beams.

### b) Novolak Paper

The hydrophobicity was determined on a conventional fuel filter paper, which contained novolak and hexamethylenetetramine for heat curing and was provided for heat curing, and the hydrophobicity was found to be 0 in each case.

Then the respective spacer was applied to the novolak paper and the paper coated with the spacer was cured with electron beams.

### c) Irradiation

The irradiation was performed on an electron emitter from WKP/Unterensingen. The manufacturer of the system was ESI. The system is designed for irradiating rolled material. Therefore the pads were glued to a backing (paper/film) and passed through the machine in this way. To prevent excessive ionization, nitrogen inertization was used in all experiments.

### d) Results of Hydrophobicity Testing

The measured increase in hydrophobicity after irradiation is listed in the following table:

| | a) Cellulose pads | | b) Novolak paper | |
|---|---|---|---|---|
| | Dose: | Dose: | Dose: | Dose: |
| Spacer | 300 kGy | 100 kGy | 300 kGy | 300 kGy |
| 2-methyl-1,3-butadiene | 0 | 0 | 0 | 0 |
| pentaerythritol | 0 | 0 | 7 | 7 |
| triacrylate | | | | |
| poly(ethylene glycol) | 0 | 0 | 7 | 7 |
| diacrylate | | | | |
| trimethylolpropane- | 7 | 7 | 7 | 7 |
| propoxylate-triacrylate | | | | |
| 1,5-hexadien-3-ol | 7 | 7 | 7 | 7 |
| 1,6-hexanediol | 0 | 0 | 7 | 7 |
| diacrylate | | | | |
| tetra(ethylene glycol) | 0 | 0 | 7 | 7 |
| diacrylate | | | | |
| 1,6-hexanediol | 0 | 0 | 7 | 7 |
| ethoxylate | | | | |
| diacrylate | | | | |
| bisphenol A | 7 | 7 | 7 | 7 |
| ethoxylate | | | | |
| diacrylate | | | | |
| Trimethylolpropane | 0 | 0 | 7 | 7 |
| ethoxylate triacrylate | | | | |
| null sample (no spacer) | 0 | 0 | 0 | 0 |

It can be seen clearly here but the curing by electron beams has already taken place at a dose of 100 kGy. The resulting hydrophobicity was 7 which is thus at the same level as that of the conventionally thermally curing paper.

The significantly inferior curing of the cellulose pads in some cases is due not to the spacer used but instead to the inhomogeneous impregnation and the much rougher and/or more fleeced surface. In most cases it was observed that the test drops were destroyed by cellulose fibers. If there was inhomogeneous impregnation of the cellulose pads, the same hydrophobicity was determined on cellulose pads and novolak paper with a respective spacer for the increase in hydrophobicity.

### III. Comparison

### Heat-Cured Fuel Filter Paper

For comparison, the conventional fuel filter paper (b) provided for heat curing was cured at 165° C. in a drying cabinet and the hydrophobicity on the back side and on the dirty side of the filter paper was determined as a function of time.

After 0 seconds, the hydrophobicity on the back side and the dirty side was 0; after 20 minutes the hydrophobicity on the back side and the dirty side was 7 and after 60 minutes the hydrophobicity was again 7 on both the back side and the dirty side of the paper.

### IV. Results

The basic suitability of electron beam curing for novolak crosslinking was demonstrated in the experiments described here. It was shown that by using suitable curing substances (spacers) a targeted hydrophobicity treatment is possible. The following table summarizes the results, taking into account the hazard classes of the respective spacers used:

| | Hazard | Evaluation |
|---|---|---|
| Curing agent | class [ ] | toxic/volatile |
| 2-methyl-1,3-butadiene | T/F | toxic |
| pentaerythritol triacrylate | X | OK |
| poly(ethylene glycol) diacrylate | X | OK |
| Trimethylolpropane propoxylate | X | OK |
| triacrylate | | |
| 1,5-hexadien-3-ol | — | too expensive |
| 1,6-hexanediol diacrylate | X | OK |
| tetra(ethylene glycol) diacrylate | C | OK |
| 1,6-hexanediol ethoxylate diacrylate | — | OK |
| bisphenol A ethoxylate diacrylate | X | OK |
| Trimethylolpropane ethoxylate | X | OK |
| triacrylate | | |

Taking into account the toxic properties of 2-methyl-1,3-butadiene and the enormous price of 1,5-hexadien-3-ol as well as the lack of efficiency of ethylene glycol dimethacrylate, the following substances can be identified as especially suitable spacers and/or curing agents for electron beam curing:

pentaerythritol triacrylate, poly(ethylene glycol) diacrylate, trimethylolpropane propoxylate triacrylate, 1,6-hexanediol diacrylate, tetra(ethylene glycol)diacrylate, 1,6-hexanediol ethoxylate diacrylate, bisphenol A ethoxylate diacrylate and trimethylolpropane ethoxylate acrylate.

1. A method for manufacturing a filter medium for technical applications, comprising:
impregnating expansion bellows made of a filter paper with a radiation curable resins and
radiation-curing the impregnated bellows.

2. The method according to claim 1, characterized in that the radiation curable resin comprises monomers, oligomers, prepolymers, polymers or mixtures thereof.

3. The method according to claim 1, characterized in that the radiation curable resin comprises unsaturated molecular groups selected from the group consisting of acyl, methacryl, vinyl or allyl groups, mono- or polyunsaturated C—C or C-heteroatom bonds and purely heteroatomic unsaturated bonds.

4. The method according to claim 1, characterized in that the resin additionally comprises a spacer or a free radical initiator.

5. The method according to claim 4, characterized in that the spacer is selected from the group consisting of:
1,3-butanediol diacrylate, 1,4-butanediol diacrylate, 1,6-hexanediol diacrylate, 1,6-hexanediol ethoxylate diacrylate, 1,6-hexanediol propoxylate diacrylate, 3-hydroxy-2,2-dimethylpropyl-3-hydroxy-2,2-dimethyl propionate diacrylate, 5-ethyl-5-(hydroxymethyl)-β,β-dimethyl-1,3-dioxane-2-ethanol diacrylate; bisphenol-A ethoxylate diacrylate, bisphenol-A glycerolate (1-glycerol/phenol)-diacrylate, bisphenol-A propoxylate diacrylate bisphenol-F ethoxylate (2 EO/phenol) diacrylate; di-(ethylene glycol) diacrylate, ethylene glycol diacrylate, fluorescein 0,0′-diacrylate, glycerol 1,3-diglycerolate diacrylate, neopentyl glycol diacrylate, neopentyl glycol propoxylate (1 PO/OH)-diacrylate, pentaerythritol diacrylate-monostearate, poly(disperse-red9-p-phenylene diacrylate), poly(ethylene glycol) diacrylate, poly-(propylene glycol)-diacrylate, propylene glycol-glycerolate diacrylate, tetra(ethylene glycol)-diacrylate, tri(propylene glycol)-diacrylate (especially as a mixture of isomers), tri(propylene glycol) glycerolate diacrylate, tricyclo-[5.2.1.2.6]decanedimethanol diacrylate, trimethylol-propane benzoate diacrylate, trimethylol-propane ethoxylate (1 EO/OH) methyl ether diacrylate; 1,3,5-triallyl-1,3,5-triazine-2,4,6(1H,3H,5H)-trione, 3-(N,N′,N′-triallyl-hydrazino)-propionic acid, triallyl 1,3,5-benzene tricarboxylate, triallyl borate, triallyl cyanurate, 2,4,6-triallyloxy-1,3,5-triazine, trimethylolpropane ethoxylate triacrylate, glycerol propoxylate (1 PO/OH) triacrylate, pentaerythritol propoxylate triacrylate, pentaerythritol triacrylate, trimethylolpropane propoxylate triacrylate, trimethylolpropane triacrylate; diallyl-2,6-dimethyl-4-(3-phenoxyphenyl)-1,4-dihydro-3,5-pyridine dicarboxylate, diallyl-2,6-dimethyl-4-(4-methyl-phenyl)-1,4-dihydro-3,5-pyridinedicarboxylate, diallyl-4-(2,4-dichlorophenyl)-2,6-di-methyl-1,4-dihydro-3,5-pyridinedicarboxylate, diallyl-4-(2-chlorophenyl)-2,6-dimethyl-1,4-dihydro-3,5-pyridine-dicarboxylate; 1,1-diallyl-1-docosanol, 1,1-diallyl-3-(1-naphthyl)-urea, 1,1-diallyl-3-(2,3-dichlorophenyl)-urea, 1,1-diallyl-3-(2,3-xylyl)-urea, 1,1-diallyl-3-(2,4,5-trichloro-phenyl)-urea, 1,1-diallyl-3-(2,4-xylyl)-urea, 1,1-diallyl-3-(2,5-dichlorophenyl)-urea, 1,1-diallyl-3-(2,5-xylyl)-urea, 1,1-diallyl-3-(2,6-diethylphenyl)-urea, 1,1-diallyl-3-(2,6-diisopropyl-phenyl)-urea, 1,1-diallyl-3-(2,6-xylyl)-urea, 1,1-diallyl-3-(2-ethyl-6-methylphenyl)-urea, 1,1-diallyl-3-(2-ethyl-phenyl)-urea, 1,1-diallyl-3-(2-methoxy-5-methylphenyl)-urea, 1,1-diallyl-3-(2-methoxyphenyl)-urea, 1,1-diallyl-3-(2-methyl-6-nitrophenyl)-urea, 1,1-diallyl-3-(3,4-dichlorophenyl)-urea, 1,1-diallyl-3-(3,4-xylyl)-urea, 1,1-diallyl-3-(3,5-xylyl)-urea, 1,1-diallyl-3-(3-chloro-benzo(β)thiophene-2-carbonyl)-thiourea; 1,3-divinyl-5-isobutyl-5-methylhydantoine, 1,4-butanediol divinyl ether, 1,4-cyclohexane dimethanol divinyl ether, 1,4-divinyl-1,1,2,2,3,3,4,4-octamethyl-tetrasilane, 1,6-hexanediol divinyl ether, 3,6-divinyl-2-methyltetrahydropyrane, 3,9-divinyl-2,4,8,10-tetraoxaspiro[5.5]undecane, di-(ethylene glycol) divinyl ether, divinylsulfone, divinyl sulfoxide, platinum(0) 1,3-divinyl-1,1,3,3-tetra-methyldisiloxane (complex solution), poly(dimethyl-siloxane-co-diphenylsiloxane) (divinyl terminated), poly(ethylene glycol) divinyl ether, tetra(ethylene glycol) divinyl ether, tri(ethylene glycol) divinyl ether, 1,1,3,3-tetramethyl-1,3-divinyldisiloxane, 1,4-pentadiene-3-ol, polymer carrier VA-Epoxy®, protoporphyrin IX, protoporphyrin IX disodium salt, protoporphyrin IX zinc (II), and the azides and homologs of all the compounds listed above.

6. The method according to claim 1, characterized in that the radiation curable resin is a phenolic resin.

7. The method according to claim 1, characterized in that the radiation-curing is performed with electron beams.

8. The method according to claim 1, characterized in that the filter paper is irradiated at an energy dose of from between 10 and 150 kGy.

9. The method according to claim 1, characterized in that the filter paper is made of cellulose.

10. The method according to claim 1, characterized in that the filter paper has a bursting strength of at least 0.1 N/mm2.

11. A filter medium for technical applications, characterized in that the filter medium is expansion bellows having a radiation cured resin layer, and the filter medium has a hydrophobicity of at least 6.

12. The filter medium according to claim 11, characterized in that the filter medium comprises filter paper having a degree of polymerization of at least 900.

13. The method according to claim 1, characterized in that the filter paper is irradiated at an energy dose of from between 50 and 100 kGy.

14. The method according to claim 1, characterized in that the filter paper is made at least in part of synthetic fibers.

15. The filter medium according to claim 11, characterized in that the filter medium is expansion bellows having a radiation cured resin layer, and the filter medium has a hydrophobicity of 7.
